(19) United States
(12) Patent Application Publication
(10) Pub. No.: US 2017/0022885 A1
(43) Pub. Date: Jan. 26, 2017

(54) INTAKE SYSTEM OF ENGINE HAVING INTAKE DUCT

(71) Applicants: Kia Motors Corporation, Seoul (KR); Hyundai Motor Company, Seoul (KR)

(72) Inventors: Joon Myung Lee, Seoul (KR); Sung Soo Kim, Gimpo-si (KR); Kyoung Ik Jang, Yongin-si (KR); Jeonjin Park, Suwon-si (KR)

(73) Assignees: Hyundai Motor Company, Seoul (KR); Kia Motors Corporation, Seoul (KR)

(21) Appl. No.: 14/957,736

(22) Filed: Dec. 3, 2015

(30) Foreign Application Priority Data
Jul. 20, 2015 (KR) 10-2015-0102667

(51) Int. Cl. F02B 29/04; F02M 35/10

(52) U.S. Cl. CPC F02B 29/0462; F02B 29/0443; F02M 35/10157

(57) ABSTRACT

An intake system of an engine having an intake duct includes an intake line disposed to transmit a gas including ambient air to a combustion chamber of an engine. An intake duct formed in a preset section of the intake line and configured to transmit the gas to the combustion chamber. The intake duct is formed of metal, and a coolant jacket formed in a preset region of an outer surface of the intake duct and disposed to cool a gas flowing in the intake duct. A coolant inlet for supplying a coolant is formed at one side of the coolant jacket and a coolant outlet for discharging the coolant is formed at another side of the coolant jacket.

### CROSS-REFERENCE TO RELATED APPLICATIONS

This application claims priority to and the benefit of Korean Patent Application No. 10-2015-0102667, filed on Jul. 20, 2015, the contents of which are incorporated by reference in its entirety.

### FIELD

The present disclosure relates to an intake system of an engine.

### BACKGROUND

The statements in this section merely provide background information related to the present disclosure and may not constitute prior art.

In general, a turbocharger is a device collecting pressure and thermal energy of an exhaust gas of an engine and compressing air introduced to an engine using the collected pressure and thermal energy to enhance performance of an internal combustion engine (hereinafter, simply referred to as an “engine”).

A general turbocharger includes a turbine wheel and a compressor wheel. An exhaust gas discharged through an exhaust manifold of an engine (E) rotates a turbine wheel of a turbocharger, and as a result, a compressor wheel connected to the turbine wheel through a connection shaft is rotated.

The compressor wheel is installed in an intake manifold or an intake line of the engine E and compresses air introduced to the engine through rotation thereof. Thus, air having high density may be supplied to a combustion chamber of the engine, without having to directly use power of the engine.

Since air having high density is supplied to the combustion chamber by the turbocharger, an amount of air supplied to the combustion chamber is increased, and accordingly, an amount of injected fuel is also increased. Thus, output corresponding to the increased amount of injected fuel may be enhanced.

A vehicle equipped with such a turbocharger may have effects of reducing fuel, reducing an exhaust gas and noise, increasing an output per weight, increasing cooling performance of an engine, and increasing an output at an alpine zone.

In such a turbocharger, fresh air at a temperature (about 150° C. or higher, and 200° C. or higher in case of a small one) significantly higher than an atmosphere temperature (25° C.) is sent to the combustion chamber of the engine, and here, in order to overcome supply of air having the high temperature, an intercooler is installed in a conduit connecting the compressor wheel and the intake manifold.

### SUMMARY

The present disclosure is an intake system of an engine having an intake duct having advantages of enhancing intake efficiency and an output by lowering an intake temperature, and simplifying a layout of an intake line and a coolant line.

One form of the present disclosure provides an intake system of an engine having an intake duct, including: an intake line disposed to transmit a gas including ambient air to a combustion chamber of an engine; an intake duct formed in a preset section of the intake line and configured to transmit the gas to the combustion chamber, wherein the intake duct is formed of metal; and a coolant jacket formed in a preset region of an outer surface of the intake duct and disposed to cool a gas flowing in the intake duct, wherein a coolant inlet to which a coolant is supplied is formed at one side of the coolant jacket and a coolant outlet from which the coolant is discharged is formed at the other side of the coolant jacket.

The intake system may further include: a turbocharger disposed to compress the gas to have preset pressure may be provided at an upper stream side of the intake duct.

The intake system may further include: a coolant jacket cover formed to be spaced apart from the outer surface of the intake duct, wherein a coolant jacket may be formed between the coolant jacket cover and the outer surface of the intake duct.

The coolant jacket cover may be integrally formed with the intake duct.

A partition may be formed to extend from one side to the other side on an inner surface of the intake duct, and the partition may be integrally formed with the intake duct.

The partition may extend from the inner surface of the intake duct corresponding to a portion where the coolant jacket is formed, to an inner surface opposite thereto.

The intake system may further include: an intercooler disposed at a lower stream side of the intake duct to cool the gas.

The coolant jacket cover may be formed along an outer circumferential surface of the intake duct, and the coolant jacket may be formed between an inner circumferential surface of the coolant jacket cover and the outer circumferential surface of the intake duct.

The coolant inlet may receive a coolant from one of cooling elements of an engine.

The cooling elements may include a heater and a radiator.

The coolant inlet may receive a coolant from a cylinder head or a cylinder block of the engine.

Another form of the present disclosure provides an intake system of an engine having an intake duct, including: an intake line disposed to transmit a gas including ambient air; a turbocharger disposed to compress the gas to have preset pressure; an intake duct formed in a preset section of the intake line at a lower stream side of the turbocharger and configured to transmit the gas to a combustion chamber, wherein the intake duct is formed of a metal; a coolant jacket formed in a preset region of an outer surface of the intake duct and having a coolant inlet, to which a coolant is received, formed at one side thereof, and a coolant outlet, from which a coolant is discharged, formed at the other side thereof; and an intercooler disposed at a lower stream side of the intake duct to cool the gas.

The intake duct may be fixed to an intake manifold, a cylinder block, or a cylinder head through a mounting bracket.

According to one form of the present disclosure, a coolant flowing in the coolant jacket formed on an outer surface of the intake duct may cool a coolant having a high temperature and high pressure and flowing in the intake duct to improve overall compressed air cooling efficiency and intake efficiency

In addition, according to one form of the present disclosure, since the coolant line is coupled to the intake duct, a layout may be simplified.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a view schematically illustrating a configuration of an intake system of an engine having an intake duct according to one form of the present disclosure;

FIG. 2 is a side view of an intake duct according to one form of the present disclosure;

FIG. 3 is a cross-sectional view of one side of the intake duct according to one form of the present disclosure;

FIG. 4 is a cross-sectional view of one side of the intake duct according to another form of the present disclosure; and

FIG. 5 is a graph illustrating an effect according to one form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

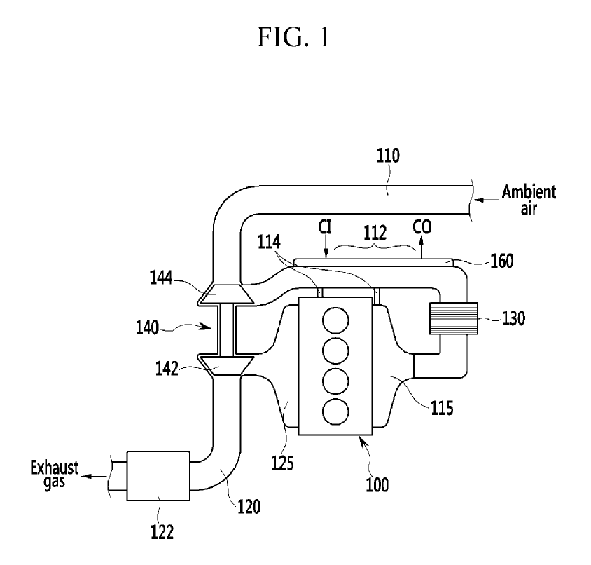

FIG. 1 is a view schematically illustrating a configuration of an intake system of an engine having an intake duct according to one form of the present disclosure.

Referring to FIG. 1, the intake system of an engine having an intake duct according to one form of the present disclosure includes an intake line 110, an intake duct 112, a coolant jacket cover 160, an intercooler 130, a mounting bracket 114, an intake manifold 112, an engine 100, an exhaust manifold 125, an exhaust line 120, a catalyst unit 122, and a turbocharger 140 including a turbine 142 and a compressor 144.

Ambient air is supplied to a combustion chamber of the engine 100 through the intake line 110, the compressor 144 of the turbocharger 140, the intake duct 112, the intercooler 130, and the intake manifold 115, and an exhaust gas burned in the combustion chamber passes through the exhaust manifold 125, the turbine 142, the exhaust line 120, and the catalyst unit 122.

The turbine 142 of the turbocharger 140 is operated by a discharge gas to rotate the compressor 144 at a high speed, and the compressor 144 compresses the gas at a high temperature and high pressure and supplies the compressed gas to the combustion chamber of the engine 100.

A section set between the compressor 144 and the intercooler 130 in the intake line 110 is configured as an intake duct 112, and a coolant jacket cover 160 is formed on a portion of an outer surface of the intake duct 112.

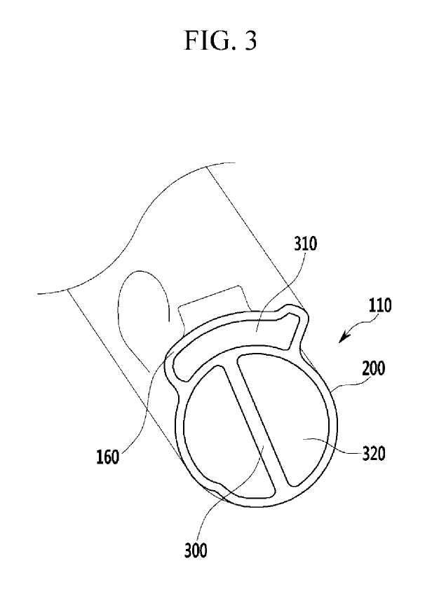

A coolant jacket 310 (FIG. 3) is formed between the coolant jacket cover 160 and an outer surface of the intake duct 112, and a coolant inlet 210 (CI) to which a coolant is supplied and a coolant outlet 220 (CO) to which a coolant is discharged are formed to be spaced apart by a preset interval on the coolant jacket cover 160.

A coolant flowing in the coolant jacket 310 of the intake duct 112 primarily cools a gas having a high temperature and high pressure and flowing in the intake duct 112, and the intercooler 130 secondarily cools a gas having a high temperature and high pressure and flowing in the intake line 110.

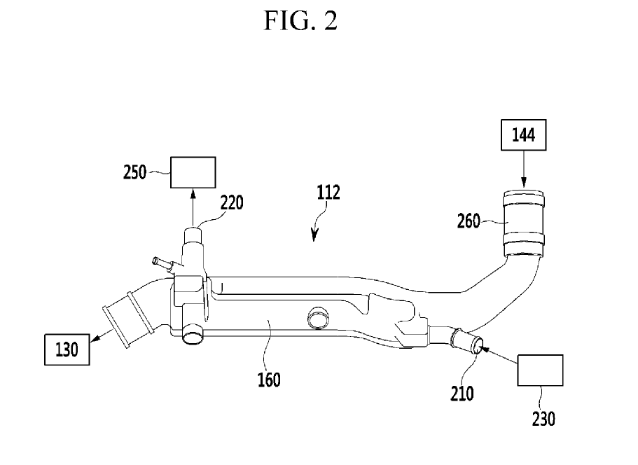

In one form of the present disclosure, the intake duct 112 has a structure fixed to the engine 100 (a cylinder block or a cylinder head) or the intake manifold 115 through the mounting bracket 114. The structure of the intake duct 112 will be described in detail with reference to FIGS. 2 and 3.

FIG. 2 is a side view of an intake duct according to one form of the present disclosure.

Referring to FIG. 2, a flexible connector 260 is disposed at an entrance side of a compressed gas of the intake duct 112, receives compressed air from the compressor 144 of the turbocharger 140.

Here, the flexible connector 260 may be formed of an elastic material to reduce vibration and noise, and the intake duct 112 may be formed of a metal such as aluminum to improve durability and cooling efficiency.

The coolant jacket cover 160 is disposed in the section set in a length direction on an outer surface of the intake duct 112. The coolant inlet 210 is disposed at one end portion of the coolant jacket cover 160, and the coolant outlet 220 is formed at the other end portion of the coolant jacket cover 160.

The coolant inlet 210 may be connected to a heater 230 of a vehicle to receive a coolant from the heater, and the coolant outlet 220 may be connected to an intake side of a coolant pump 250

In addition, the coolant inlet may receive a coolant from the engine, that is, the cylinder head or the cylinder block, and may receive a coolant from a coolant control valve (or a thermostat).

In one form of the present disclosure, an entrance side of the intake duct 112 may be connected to the compressor 144 of the turbocharger 140, and an exit side of the intake duct 112 may be connected to the intercooler 130. The intake duct 112 primarily cools a compressed gas having a high temperature and high pressure using a coolant flowing inside of the coolant jacket cover 160 and the intercooler 130 may secondarily cools the compressed gas having a high temperature and high pressure, thus enhancing overall cooling efficiency.

A coolant line is formed to extend from the heater 230 to the coolant pump 250.

However, in one form of the present disclosure, since the coolant line is coupled to the intake duct 112, a layout may be simplified, and since the coolant line cools compressed gas having a high temperature passing through the intake duct 112, overall intake efficiency may be improved.

FIG. 3 is a cross-sectional view of one side of the intake duct according to one form of the present disclosure.

Referring to FIG. 3, the coolant jacket cover 160 is formed to be spaced apart from the outer surface of the intake duct 112 by a preset interval, and the coolant jacket 310 is formed between the coolant jacket cover 160 and an outer surface of the intake duct 112.

As illustrated, the coolant jacket cover 160 is integrally formed with the intake duct 112, and the coolant jacket 310 may be formed only in a preset region on the outer surface of the intake duct 112. A partition 300 separating a flow path of compressed gas inside the intake duct 112, and the compressed gas 320 flows at both sides of the partition 300.

One end of the partition 300 is connected to one side of an inner circumferential surface of the intake duct 112 corresponding to the coolant jacket 310, and the other end of the partition 300 is connected to the other side of the inner circumferential surface of the intake duct 112. The partition 300 may be integrally formed with the intake duct 112 and may be formed to extend by a preset distance inside the intake duct 112 in a direction in which the compressed gas flows. The partition 300 may be unitarily formed with the intake duct 112 as a monolithic structure.

The partition 300 may allow a coolant flowing in the coolant jacket 310 to easily absorb heat from compressed air flowing in the intake duct 112, and reinforce rigidity of the intake duct 112.

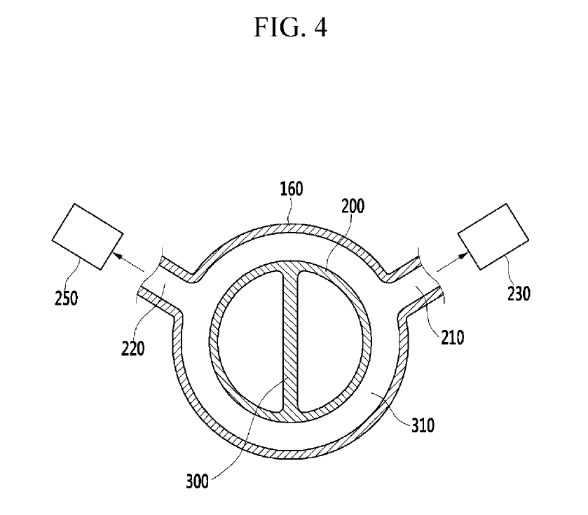

FIG. 4 is a cross-sectional view of one side of the intake duct according to another form of the present disclosure.

Referring to FIG. 4, the coolant jacket cover 160 is disposed at a preset interval on an outer circumferential surface of the intake duct 112, and the coolant jacket 310 is formed between the outer circumferential surface of the intake duct 112 and the coolant jacket cover 160.

As illustrated, the coolant jacket 310 is formed along the outer circumferential surface of the intake duct 112, having a structure of surrounding the intake duct 112, and a coolant inlet 210 to which a coolant is supplied is formed at one side of the coolant jacket cover 160 and a coolant outlet 220 from which a coolant is discharged is formed at the other side of the coolant jacket cover 160.

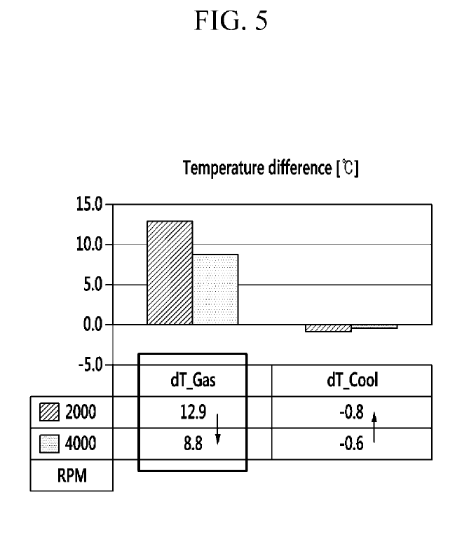

FIG. 5 is a graph illustrating an effect according to one form of the present disclosure.

Referring to FIG. 5, 2000 and 4000 indicate revolution per minute (RPM) of the engine, and the vertical axis represents a temperature difference.

dT_Gas indicates a change in temperature between the entrance and the exit of the intake duct 112, and illustrates a gas is cooled by about 12.9° C. at the RPM 2000 and is cooled by about 8.8° C. at the RPM of 4000.

dT_Cool indicates a change in temperature between the coolant inlet 210 and the coolant outlet 220. As illustrated about 0.8° C. is increased at the RPM of 2000, and about 0.5° C. is increased at the RPM of 4000.

The description of the disclosure is merely exemplary in nature and, thus, variations that do not depart from the substance of the disclosure are intended to be within the scope of the disclosure. Such variations are not to be regarded as a departure from the spirit and scope of the disclosure.

<Description of symbols>

| | |
|---|---|
| 100: engine | 110: intake line |
| 112: intake duct | 114: mounting bracket |
| 115: intake manifold | 120: exhaust line |
| 122: catalyst unit | 125: exhaust manifold |
| 130: intercooler | 140: turbo charger |
| 142: turbine | 144: compressor |
| 160: coolant jacket cover | 210: supply hole |
| 220: outlet | 230: heater |
| 250: coolant pump | 260: flexible connector |
| 300: partition | 310: coolant jacket |
| 320: compressed gas | |

What is claimed is:

1. An intake system of an engine having an intake duct, the intake system comprising:
an intake line disposed to transmit a gas to a combustion chamber of an engine;
an intake duct formed in a preset section of the intake line and configured to transmit the gas to the combustion chamber, wherein the intake duct is formed of metal; and
a coolant jacket formed in a preset region of an outer surface of the intake duct and disposed to cool a gas flowing in the intake duct,
wherein a coolant inlet to which a coolant is supplied is formed at a first side of the coolant jacket, and a coolant outlet from which the coolant is discharged is formed at a second side of the coolant jacket.

2. The intake system of claim 1, further comprising:
a turbocharger disposed to compress the gas to a preset pressure provided at an upper stream side of the intake duct.

3. The intake system of claim 1, further comprising:
a coolant jacket cover formed to be spaced apart from the outer surface of the intake duct,
wherein a coolant jacket is formed between the coolant jacket cover and the outer surface of the intake duct.

4. The intake system of claim 3, wherein the coolant jacket cover is integrally formed with the intake duct.

5. The intake system of claim 3, wherein the coolant jacket cover is formed along an outer circumferential surface of the intake duct, and the coolant jacket is formed between an inner circumferential surface of the coolant jacket cover and the outer circumferential surface of the intake duct.

6. The intake system of claim 3, wherein the coolant inlet receives a coolant from a cooling element of an engine.

7. The intake system of claim 6, wherein the cooling element is one of a heater and a radiator.

8. The intake system of claim 3, wherein the coolant inlet receives the coolant from a cylinder head or a cylinder block of the engine.

9. The intake system of claim 3, wherein the coolant jacket cover is unitarily formed with the intake duct.

10. The intake system of claim 1, wherein a partition is formed to extend from the first side to the second side on an inner surface of the intake duct, and the partition is integrally formed with the intake duct.

11. The intake system of claim 10, wherein the partition extends from the inner surface of the intake duct corresponding to a portion where the coolant jacket is formed, to an inner surface opposite thereto.

12. The intake system of claim 1, further comprising an intercooler disposed at a lower stream side of the intake duct to cool the gas.

13. An intake system of an engine having an intake duct, the intake system comprising:
an intake line disposed to transmit a gas;
a turbocharger disposed to compress the gas to have preset pressure;
an intake duct formed in a preset section of the intake line at a lower stream side of the turbocharger and configured to transmit the gas to a combustion chamber, wherein the intake duct is formed of a metal;
a coolant jacket formed in a preset region of an outer surface of the intake duct and having a coolant inlet, to which a coolant is received, formed at a first side thereof, and a coolant outlet, from which a coolant is discharged, formed at a second side thereof; and
an intercooler disposed at a lower stream side of the intake duct to cool the gas.

14. The intake system of claim 13, wherein the intake duct is fixed to an intake manifold, a cylinder block, or a cylinder head through a mounting bracket.
